(19) United States
(12) Patent Application Publication
(10) Pub. No.: US 2014/0067775 A1
(43) Pub. Date: Mar. 6, 2014

(54) SYSTEM, METHOD AND COMPUTER PROGRAM PRODUCT FOR CONDITIONALLY PERFORMING DE-DUPING ON DATA

(71) Applicant: salesforce.com,inc, San Francisco, CA (US)

(72) Inventor: Guillaume Le Stum, San Francisco, CA (US)

(21) Appl. No.: 13/927,037

(22) Filed: Jun. 25, 2013

Related U.S. Application Data
(60) Provisional application No. 61/697,052, filed on Sep. 5, 2012.

(51) Int. Cl. G06F 17/30

(52) U.S. Cl. CPC G06F 17/30156
USPC 707/692

(57) ABSTRACT

In accordance with embodiments, there are provided mechanisms and methods for conditionally performing de-duping on data. These mechanisms and methods for conditionally performing de-duping on data can enable increased resource efficiency, optimized data analysis, faster report generation, etc.

### CLAIM OF PRIORITY

This application claims the benefit of U.S. Provisional Patent Application No. 61/697,052, entitled “SYSTEM AND METHOD FOR OPTIMIZING DATA SUBTOTALING,” by Guillaume Le Stum, filed Sep. 5, 2012(Attorney Docket No. 995PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to data objects, and more particularly to performing de-duping on data associated with data objects.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Data reports are a useful tool that allow for data trending and analysis. Unfortunately, techniques for managing the creation of such data reports have been associated with various limitations. Just by way of example, techniques for managing duplicate data while running a report may be both time and resource intensive, and may perform unnecessary analysis operations. Accordingly, it is desirable to provide techniques that allow for the optimized management of duplicate data when running a report.

### BRIEF SUMMARY

In accordance with embodiments, there are provided mechanisms and methods for conditionally performing de-duping on data. These mechanisms and methods for conditionally performing de-duping on data can enable increased resource efficiency, optimized data analysis, faster report generation, etc.

In an embodiment and by way of example, a method for conditionally performing de-duping on data is provided. In one embodiment, metadata associated with a plurality of objects is identified. Additionally, the metadata is analyzed. Further, de-duping is conditionally performed on data associated with one or more of the plurality of objects, based on the analysis.

While one or more implementations and techniques are described with reference to an embodiment in which conditionally performing de-duping on data is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for conditionally performing de-duping on data, in accordance with one embodiment;

FIG. 2 illustrates a method for conditionally performing de-duping during data summing, in accordance with another embodiment;

FIG. 3 illustrates a block diagram of an example of an environment wherein an on-demand database system might be used; and

FIG. 4 illustrates a block diagram of an embodiment of elements of FIG. 3 and various possible interconnections between these elements.

### DETAILED DESCRIPTION

### General Overview

Systems and methods are provided for conditionally performing de-duping on data.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for conditionally performing de-duping on data will be described with reference to example embodiments.

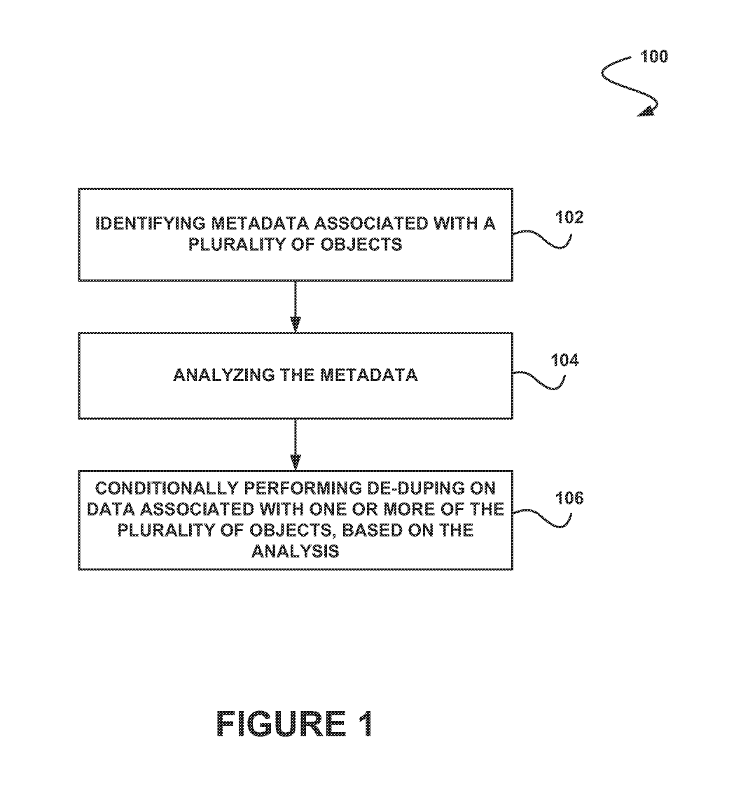

FIG. 1 illustrates a method 100 for conditionally performing de-duping on data, in accordance with one embodiment. As shown in operation 102, metadata associated with a plurality of objects is identified. In one embodiment, the plurality of objects may be included within a system. For example, the plurality of objects may be included within a multi-tenant on-demand database system. In another embodiment, one or more of the plurality of objects may include a table. For example, each of the plurality of objects may include a table including one or more rows, one or more columns, etc.

Additionally, in one embodiment, data may be stored within one or more of the plurality of objects. For example, one or more rows and/or columns in an object may include one or more data values (e.g., numeric values, alphanumeric values, etc.). In another embodiment, the metadata may be associated with one or more foreign keys. In yet another embodiment, the metadata may describe one or more joins (e.g., join relationships, etc.) between the plurality of objects.

Further, in one embodiment, the metadata may indicate one or more relationships between entries in one object and entries in another object. For example, the metadata may indicate a 1-1 join relationship between objects (e.g., that a single entry in one object corresponds to a single entry in another object), a 1-n join relationship between objects (e.g., that a single entry in one object corresponds to multiple entries in another object), etc. In another example, the metadata may indicate an n-1 join relationship between objects (e.g., that a multiple entries in one object correspond to a single entry in another object), an n-n join relationship between objects (e.g., that multiple entries in one object correspond to multiple entries in another object), etc.

Further still, in one embodiment, the metadata associated with a plurality of objects may be identified in response to a request. For example, the metadata associated with a plurality of objects may be identified in response to a request to create a report utilizing one or more of the plurality of objects. In another embodiment, the metadata associated with a plurality of objects may be identified as part of the running of a report analysis. In yet another embodiment, the metadata associated with the plurality of objects may be identified by performing a spidering operation. For example, the metadata associated with the plurality of objects may be identified by traversing all possible report join relationships between the plurality of objects.

Also, in one embodiment, the metadata may be associated with a report. For example, the metadata may include data describing a structure of a report (e.g., a report join structure, etc.) that indicates what data is retrieved from the objects during the running of the report, in what manner the data is retrieved from the objects, what data from the objects is analyzed during the running of the report, etc. another embodiment, the report may include a plurality of actions to be performed on data within one or more of the objects. For example, the report may include an indication of data to be retrieved from one or more of the objects, operations to be performed on the data, results to be output (e.g., displayed to a user, etc.), etc.

Also, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

In addition, as shown in operation 104, the metadata is analyzed. In one embodiment, analyzing the metadata may include analyzing one or more joins associated with the plurality of objects. In another embodiment, analyzing the metadata may include determining whether one or more predetermined joins exist within the metadata. For example, analyzing the metadata may include determining Whether one or more 1-n or n-n join relationships exist between the plurality of objects.

Furthermore, in one embodiment, the metadata may be analyzed in the context of a report. In another embodiment, analyzing the metadata may include determining whether it is possible for data within one or more of the objects to appear more than once during the running of the report. For example, if the report includes the performance of an operation, analyzing the metadata may include determining whether data in one or more of the plurality of objects can appear more than once in a result set on which the operation is performed.

Further still, in one embodiment, analyzing the metadata may include analyzing one or more joins using a predetermined mechanism. For example, analyzing the metadata may include analyzing identified joins using a logical query mechanism. In another example, analyzing the metadata may include analyzing identified joins using a query table mechanism. In yet another example, analyzing the metadata may include analyzing identified joins using a structured query language (SQL) query table mechanism.

Also, as shown in operation 106, de-duping is conditionally performed on data associated with one or more of the plurality of objects, based on the analysis. In one embodiment, de-duping may be performed in association with one or more actions. For example, de-duping may be performed in association with the running of a report, where the report is associated with one or more of the plurality of objects. In another example, de-duping may be performed in association with a sum operation, a count distinct operation, etc,

Additionally, in one embodiment, performing de-duping on the data may include searching for duplicate values within the data. For example, any multiple instances of one or more values retrieved from the one or more objects that are associated with an operation being performed on the data may be identified, and the operation may be adjusted accordingly to reflect the multiple instances. In another example, when computing a subtotal or total utilizing the data, any data element identified as a duplicate may be counted only once in the subtotal or total.

Further, in one embodiment, a report may be run in association with one or more of the plurality of objects, and de-duping may be performed on data associated with one or more of the plurality of objects if results of the analysis indicate that it is possible for the data to appear more than once during one or more actions performed by the report. For example, running the report on one or more of the plurality of objects may result in a result set, and de-duping may be performed on data associated with one or more of the plurality of objects if results of the analysis indicate that it is possible that the data can appear more than once in the result set of the report.

Further still, in one embodiment, a report may be run in association with one or more of the plurality of objects, and de-duping may not be performed on data associated with one or more of the plurality of objects if results of the analysis indicate that it is not possible for the data to appear more than once during one or more actions performed by the report. For example, running the report on one or more of the plurality of objects may result in a result set, and de-duping may not be performed on data associated with one or more of the plurality of objects if results of the analysis indicate that it is not possible that the data can appear more than once in the result set of the report.

Also, in one embodiment, conditionally performing de-duping on data associated with one or more of the plurality of objects may include performing de-duping on the data only when one or more report join relationships are encountered. For example, de-duping may be skipped for data associated with one or more of the plurality of objects if no 1-n or n-n join relationships are detected in association with the data.

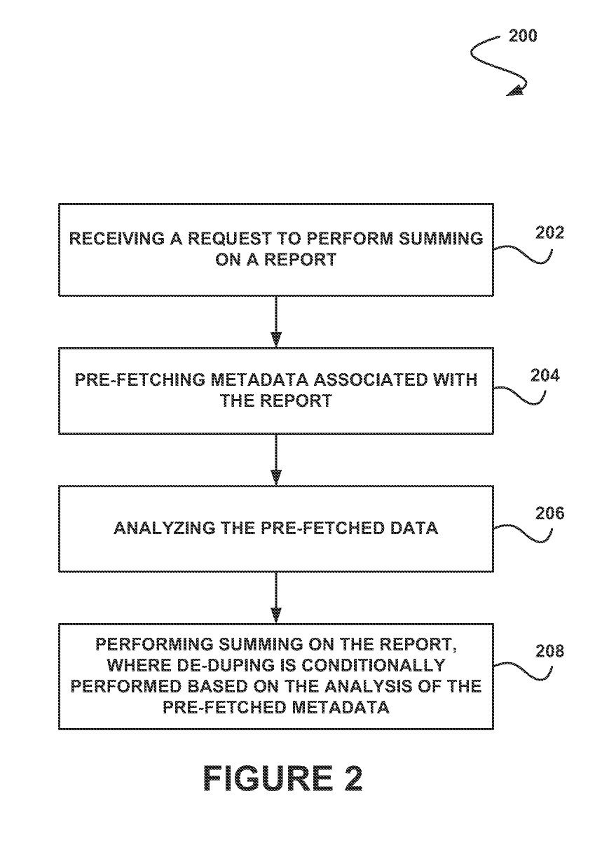

FIG. 2 illustrates a method 200 for conditionally performing de-duping during data summing, in accordance with another embodiment. As an option, the present method 200 may be carried out in the context of the functionality of FIG. 1. Of course, however, the method 200 may be carried out in any desired environment. The aforementioned definitions may apply during the present description.

As shown in operation 202, a request to perform summing on a report is received. In one embodiment, the report may include data retrieved from one or more objects within a system. For example, the report may include a plurality of values retrieved from a plurality of objects within the system. In another embodiment, the summing may include subtotaling, totaling, etc. For example, the summing may include adding together a plurality of values from within the report. In yet another embodiment, averaging may be performed in addition to the summing, instead of the summing, etc.

Additionally, in one embodiment, the summing may be used in data analysis. For example, subtotaling data reports may allow one or more entities to analyze trends in data. In another embodiment, an organization within a system may use summing to group sets of information and compare subtotals for each set against an overall total, which may provide cascading sets of information.

Further, as shown in operation 204, metadata associated with the report is pre-fetched. In one embodiment, the metadata may include foreign key metadata. In another embodiment, the metadata may include report join relationships. For example, the metadata may include join relationships between objects from which data is retrieved for the report. In yet another embodiment, pre-fetching the metadata may include spidering all join relationships within the report, starting at a summary entity of the report. In this way, the retrieved metadata may be indicative of a join structure of the report.

Further still, as shown in operation 206, the pre-fetched metadata is analyzed. In one embodiment, analyzing the pre-fetched data may include determining whether an entity can appear more than once in a result set of the report. In another embodiment, analyzing the pre-fetched data may include determining whether one or more report join relationships include a 1-n or n-n relationship.

Also, in one embodiment, analyzing the pre-fetched data may include analyzing joins using a logical query mechanism. For example, a logical query mechanism may include fields such as ‘logical-query-definition’ and ‘query-table’ and may contain all the logical tables expressing the query without splitting the custom field data into a different table. In another embodiment, the ‘query-table’ filed can configure the information about join cardinality. The logical query mechanism may be at the highest level and may include sufficient join information. This mechanism may not require pre-queries and may allow users to push down summaries.

In addition, in one embodiment, analyzing the pre-fetched data may include analyzing joins using a query table mechanism. For example, a query table mechanism may include fields such as ‘optimized-query-definition’ and ‘query-table’ and may contain all of the tables offered by the logical tables mechanism along with additional tables for a sorting mechanism.

Furthermore, in one embodiment, analyzing the pre--fetched data may include analyzing joins using a SQL query table mechanism. This may include all the tables at a lowest level of the system; however, tables may be visible at sharing (e.g., security etc.), scope and currency level. In this way, further optimization may be enabled for cases where filtering or grouping by an entity ID may reduce cardinalities and where de-duping may be skipped only for some grouping.

Further still, as shown in operation 208, summing is performed on the report, and de-duping is conditionally performed based on the analysis of the ply-fetched metadata. In one embodiment, the summing may include adding one or more values within one or more portions of the report together to create a total amount. For example, a plurality of values within a revenue column of the report may be summed within the report to create a total revenue value for that column. In another embodiment, performing de-duping may include determining whether duplicate values exist for one or more portions of the report.

Also, in one embodiment, de-duping may be performed for a particular portion of the report only if the report join relationships associated with those portions of the report indicate a 1-n or n-n relationship. In another embodiment, de-duping may not be performed for a particular portion of the report only if the report join relationships associated with those portions of the report do not indicate a 1-n or n-n relationship.

In this way, metadata may be pre-fetched to determine de-duping data points during the computation of one or more totals for a report. In one embodiment, this may be performed by optimizing distinct aggregations through selective analysis of the report and by using a single pass traversal of a query tree with backtracking.

Table 1 illustrates an exemplary portion of a report result set associated with an Account object and an Opportunity object. Of course, it should be noted that the portion of the report shown in Table 1 is set forth for illustrative purposes only, and thus should not be construed as limiting in any manner.

TABLE 1

| Account ID | Account Revenue | Opportunity ID | Opportunity Amount |
|---|---|---|---|
| A1 | 7 | 01.1 | 1 |
| A1 | 7 | 01.2 | 2 |
| A2 | 9 | 02.1 | 8 |
| A2 | 9 | 02.2 | 4 |

As shown in Table 1, when an exemplary “Account” object is analyzed in conjunction with an “Opportunity” object, the “Account ID” field of the “Account” object has values “A1” and “A2” that both appear twice in the report result set (and are therefore duplicates of the “Account ID” field in the report). Additionally, the “Account Revenue” field of the “Account” object has values “7” and “9” (associated with “Account ID” field values “A1” and “A2,” respectively) that also appear twice in the report result set (and are therefore duplicates of the “Account Revenue” field in the report).

Additionally, upon analyzing the join relationship between the “Account” object and the “Opportunity” object, it may be determined that there is a 1-n relationship between the “Account” object and the “Opportunity” object. Therefore, de-duping may be performed when determining a sum of the values in the “Account Revenue” field of the “Account” object within the report. This de-duping may identify the duplicate values within the “Account Revenue” field of the “Account” object, and such values may be only counted once during a summing operation within the “Account Revenue” column of the report.

Further, upon analyzing the join relationship between the “Opportunity” object and the “Account” object (e,g., the reverse of the join relationship between the “Account” object and the “Opportunity” object), it may be determined that there is an n-1 relationship between the “Opportunity” object and the “Account” object. Therefore, de-duping may not be performed when determining a sum of the values in the “Opportunity Amount” field of the “Opportunity” object within the report. This de-duping may not be necessary since no duplicate values may possibly exist within the “Opportunity Amount” column of the report.

Table 2 illustrates an exemplary portion of a report result set associated only with an Account object. Of course, it should be noted that the portion of the report shown in Table 2 is set forth for illustrative purposes only, and thus should not be construed as limiting in any manner.

TABLE 2

| Account ID | Account Revenue |
|---|---|
| A1 | 7 |
| A2 | 9 |

As shown in Table 2, when an “Account” object is analyzed by itself, the “Account ID” field of the “Account” object has values “A1” and “A2” that only appear once in the report result set. Since no join relationships exist with the “Account” object within the report, it may be determined that there are no 1-n relationships or n-n relationships between the “Account” object and any other object of the report. Therefore, de-duping may not be performed when determining a sum of the values in the “Account Revenue” field of the “Account” object within the report since no duplicate values may possibly exist within the “Opportunity Amount” column of the report.

In this way, duplicate data may only be counted once in any total or subtotal of the report, and de-duping may be avoided when performing summing in the report when it is not possible for duplicates to exist within the report.

### System Overview

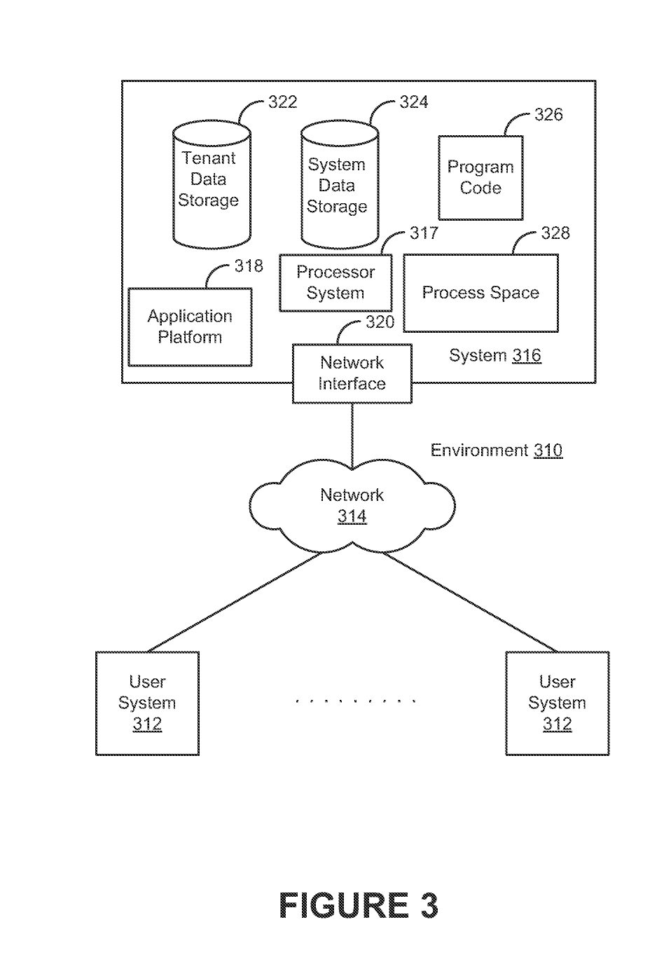

FIG. 3 illustrates a block diagram of an environment 310 wherein an on-demand database system might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

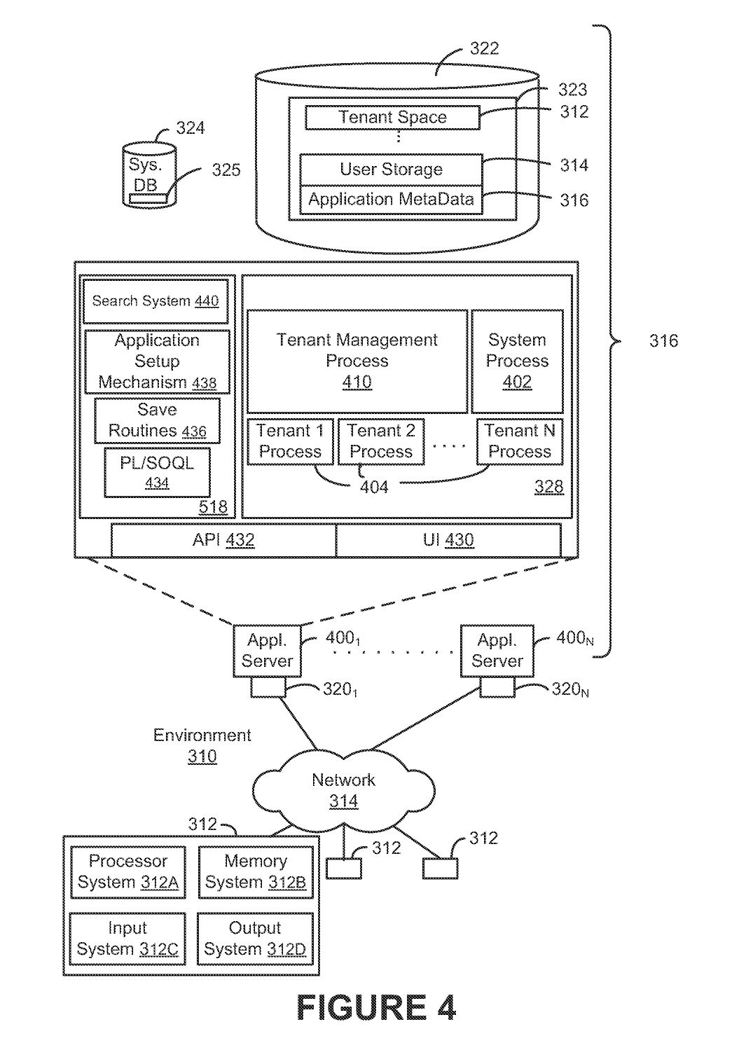

Environment 310 is an environment in which an on-demand database system exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database system, which is system 316.

An on-demand database system, such as system 316, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database system 316 may include an application platform 318 that enables creation, managing and executing one or more applications developed by the provider of the on-demand database system, users accessing the on-demand database system via user systems 312, or third party application developers accessing the on-demand database system via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP. etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdiive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN. LAN, etc.) using any communication medium and protocols (e.g., TCP/IP, HTTP, HTTPS, Ethernet, e(c.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more :logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3, Regarding user system 312, processor system 312A may be any combination of one or more processors. Memory system 312B may be any combination of one or more memory devices, short term, and/or long term memory. Input system 312 may be any combination of input devices, such as one or more keyboards, mice, trackball s, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 4001 might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow--up data, performance data, goals and progress data, etc., all applicable to that user's personal sales process in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields, U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system in certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for identifying metadata associated with a plurality of objects;
computer code for analyzing the metadata; and
computer code for conditionally performing de-duping on data associated with one or more of the plurality of objects, based on the analysis.

2. The computer program product of claim 1, wherein the metadata describes one or more joins between the plurality of objects.

3. The computer program product of claim 1, wherein the metadata indicates one of a 1-1 join relationship between objects, 1-n join relationship between objects, an n-1 join relationship between objects, and an n-n join relationship between objects.

4. The computer program product of claim 1, wherein the metadata associated with the plurality of objects is identified by performing a spidering operation.

5. The computer program product of claim 1, the metadata is associated with a report.

6. The computer program product of claim 1, wherein the metadata includes data describing a structure of a report.

7. The computer program product of claim 1, wherein analyzing the metadata includes determining whether one or more predetermined joins exist within the metadata.

8. The computer program product of claim 5, wherein analyzing the metadata includes determining whether it is possible for data within one or more of the objects to appear more than once during a running of the report.

9. The computer program product of claim 1, wherein analyzing the metadata includes analyzing one or more joins using a predetermined mechanism.

10. The computer program product of claim 1, wherein analyzing the metadata includes analyzing identified joins using a logical query mechanism.

11. The computer program product of claim 1, wherein analyzing the metadata includes analyzing identified joins using a query table mechanism.

12. The computer program product of claim 1, wherein analyzing the metadata includes analyzing identified joins using a structured query language (SQL) query table mechanism.

13. The computer program product of claim 1, wherein the de-duping is performed in association with a sum operation.

14. The computer program product of claim 1, wherein de-duping is performed in association with a count distinct operation.

15. The computer program product of claim 1, wherein a report is run in association with one or more of the plurality of objects, and de-duping is performed on data associated with one or more of the plurality of objects if results of the analysis indicate that it is possible for the data to appear more than once during one or more actions performed by the report.

16. The computer program product of claim 1, wherein a report is run in association with one or more of the plurality of objects, and de-duping is not performed on data associated with one or more of the plurality of objects if results of the analysis indicate that it is not possible for the data to appear more than once during one or more actions performed by the report.

17. The computer program product of claim 1, wherein conditionally performing de-duping on data associated with one or more of the plurality of objects includes performing de-duping on the data only when one or more report join relationships are encountered.

18. The computer program product of claim 17, wherein de-duping is skipped for data associated with one or more of the plurality of objects if no 1-n or n-n join relationships are detected in association with the data.

19. A method, comprising:
identifying metadata associated with a plurality of objects;
analyzing the metadata; and
conditionally performing de-duping on data associated with one or more of the plurality of objects, based on the analysis.

20. An apparatus, comprising:
a processor for:
identifying metadata associated with a plurality objects;
analyzing the metadata; and
conditionally performing de-duping on data associated with one or more of the plurality of objects, based on the analysis.

21. A method for transmitting code for use in a multi-tenant database system on a transmission medium, the method comprising:
transmitting code for identifying metadata associated with a plurality of objects;
transmitting code for analyzing the metadata; and
transmitting code for conditionally performing de-duping on data associated with one or more of the plurality of objects, based on the analysis.
